(19) United States
(12) Patent Application Publication
(10) Pub. No.: US 2004/0002925 A1
(43) Pub. Date: Jan. 1, 2004

(54) System and method for optimizing postal rates and discounts

(75) Inventor: Jason A. Gordon, Southport, CT (US)

Correspondence Address: PITNEY BOWES INC., 35 WATERVIEW DRIVE, P.O. BOX 3000, MSC 26-22, SHELTON, CT, 06484-8000, US

(73) Assignee: Pitney Bowes Inc., Stamford, CT (US)

(21) Appl. No.: 10/064,264

(22) Filed: Jun. 26, 2002

(51) Int. Cl. G06F 17/00

(52) U.S. Cl. 705/401

(57) ABSTRACT

A method and system for optimizing rates and discounts is described. A carrier utilizes historical or real time customer data to provide dynamic time dependent discounts to at least one targeted customer. In one embodiment, the discount is provided on a first-come, first-served basis until a desired targeted volume increase is achieved.

### BACKGROUND OF INVENTION

The illustrative embodiments disclosed in the present application are useful in systems including those for providing dynamic pricing systems and more particularly are useful in systems including those for providing postal carrier work flow balancing through the use of dynamic discounts.

Many transportation companies and organizations provide carrier services for delivering items. Certain carriers provide freight shipping services for items by the truckload and may also ship less than truckload (LTL) shipments. Some companies specialize in shipping small packages and some carriers specialize in providing express service. Such carriers often publish rate schedules based upon the size and weight of a package and the distance that it is to travel. Additionally, some carriers provide contract rates that are lower than published rates as a method of providing a volume discount.

Many countries have postal services for the delivery of mail. Several organizational structures are possible for postal systems. A postal system may be provided as a government postal system through a bureaucratic government agency. A postal system may be provided as a quasi-governmental entity as a company owned and regulated by a government. Furthermore, a postal system may consist of non-governmental entities that may be regulated or deregulated. Some or all of the traditional functions of a postal authority may be open to some form of competition from both domestic and foreign organizations.

The United States Postal Service (USPS) operates under a universal service obligation and provides mail delivery to every household and business in the United States. The USPS delivers many types of mailpieces including letters, large envelopes, newspapers, catalogues, circulars, magazines, postcards, periodicals and parcels. The USPS collects, sorts, transports and delivers the mail to every household and business in the United States. The USPS recently determined that it delivered a daily average of 687 million pieces of mail to 138 million addresses. The USPS utilized nearly 770,000 employees, 215,000 vehicles, over 38,000 post office units, 270 processing plants, 63 airport mail facilities, 21 bulk-mail centers and other facilities. The USPS also utilized private sector contractors for highway, air, rail and water transportation services. The fixed cost associated with the universal service obligation approaches almost 50% of total postal cost and does not generally vary greatly with routine mail volume changes.

Mailpieces are sometimes characterized in segments according to the type of mailpiece such as the segment described as lettermail that may account for up to 60% of postal revenue. Additionally, segments are sometimes characterized into segments or sub-segments according to the purpose of the mailpiece such as financial lettermail that includes bills, invoices, financial statements and payments. The segment known as lettermail advertising includes individualized business letters. The mail segment known as direct mail is primarily composed of advertising that is usually sent bulk rate. The direct mail mailer performs a portion of processing before submitting the mail in a work-sharing arrangement. The catalog segment is another large segment of mail. Finally, parcels are an important segment of mail.

The rate structure for U.S. mail is a matter of postal laws and rules that strive to achieve a statutory mandate that the USPS operate according to a break-even model such that the USPS does not earn a rate of return on investment. Accordingly, the rate structure is designed to provide fair and equitable rates to ensure that revenue exceeds expenses in order to cover operating expenditures and support capital expenditures. The USPS rate change process involves the Postal Service Board of Governors and a hearing process before the Postal Rate Commission.

Early postal systems utilized a system of payment whereby the recipient paid for the postage upon receipt and in which the postage rate depended upon distance traveled. Thereafter, a sender-pays-all system was utilized in which a single postage rate evidenced by a stamp was used for any letter and the rate did not depend upon the distance to be traveled.

In the United States, payment for mail is prepaid through the use of stamps, a postage meter indicia-evidencing pre-payment for postage or through the use of a mail permit and manifest intake procedure. Other countries employ post-paid mail services.

The USPS utilizes a class-based postage rating system that is based largely upon two types of classes that are defined here. First, there are the service class distinctions that provide for differing prices for mailpieces having different weights or sizes. Such distinctions are presumably based upon the cost of transportation and delivery. Similarly, there is a price distinction based upon targeted delivery times wherein the rating distinction is presumably based upon a perception of the value of the service and perhaps the lower cost of slower transportation modes. Furthermore, there are the work-share classes wherein the customer receives a discount from the applicable rate where the customer performs some of the traditional post functions such as in the area of collection and sorting. The USPS recently found that over 66% of mail consisted of mail utilizing some type of work-sharing discount. Business mailers producing large quantities of regional or national mail typically create such mail.

Small volume mailers generally deposit prepaid mail into postal street mailboxes and such mail is frequently referred to as collection mail. Larger volume mailers may submit mail directly to postal processing facilities and may include a manifest or statement of mailing. Such mailings are frequently referred to as controlled acceptance mail.

In the United States, the mail delivery service is a service in which labor costs are incurred after the purchaseA prior reference directed to Flexible Billing Rate for Mail Communication Systems is described in U.S. Pat. No. 4,949,272 to Vanourek, et al. ('272 patent) and is incorporated herein by reference in its entirety. The '272 patent describes among other things a system used for relieving a central postage facility of certain mail handling tasks utilizing a pre-processing system known as work sharing. The mailer will perform certain traditional postal service functions such as adding a destination zip code barcode to an envelope in return for a work-sharing discount. The mailer may be required to provide certifications that the work sharing functions were properly performed. The '272 patent describes among other things a system for providing a billing plan to a customer in order to facilitate billing for items such as mailing machine service charges, rental fees and supply costs.

Work-sharing discounts may be substantial and may depend upon total volume processed in a single pre-sort mailing. Accordingly, a system for merging mailings may provide some efficiency for mail delivery systems. A prior reference directed toward Optimizing Mail Delivery Systems By Merging Mailings is described in U.S. Pat. No. 5,051,914 to Sansone, et al. ('914 patent) and is incorporated herein by reference in its entirety. The '914 patent describes among other things a system and method for merging mailings such that greater postal discounts may be achieved. The reference describes a system having logistics planning capability including a system in which the postal authority provides logistical capacity information that might allow a user to time mail drop-offs during slack periods that may allow more efficient processing of mail.

A prior system for a Mail Processing System with Unique Mailpiece Authorization Assigned in Advance of Mailpieces Entering a Carrier Service Mail Processing Stream is described in U.S. Pat. No. 5,936,865 to Pintsov, et al. ('865 patent) and is incorporated herein by reference in its entirety. The '865 patent describes among other things a system allowing for communication between a mailer and a postal authority such that the postal authority obtains information regarding mailpieces likely to enter the mail stream that may enable the postal authority to perform logistical planning for the delivery of those mailpieces.

Mailing machines are commercially available that include a postage meter. For example, the Galaxy™ Mailing Systems and Paragon® II Mail Processor systems available from Pitney Bowes Inc. of Stamford, Conn., include a postage meter system that stores postage. The Postage by Phone® system available from Pitney Bowes Inc. may be used to remotely add postage to such postage meters. Certain mailing machines include a scale or other parameter-capturing device to capture rating data. They may also include a service rate database that is used by a processor to determine correct postage based upon mailpiece data such as weight and service data such as the class of service desired. Certain postal authorities require that the rate information of a mailing machine be kept up to date, while other postal authorities do not impose such a requirement. For example, when the postal authority implements a new rate schedule, the service rate databases may be updated by the manufacturer utilizing a process of sending each customer a memory chip or floppy diskette that includes the new service rate database and the effective date of the change.

### SUMMARY OF INVENTION

The application describes illustrative embodiments with reference to postal systems, but may be advantageously used with other systems as well.

In one embodiment, a rate delivery processor and at least one customer processor coordinate communicating and installing a second rate schedule having applicability data.

In another embodiment, a data processor and the customer processor coordinate the upload of mailing data from the customer processor to a data processor. The data processor determines whether a second rate schedule meets applicable criteria and if so, determines the applicable second rate schedule and facilitates the transfer of the second rate schedule to the customer processor.

In another embodiment, the customer processor allows a carrier processor access to data that may include data regarding items sent or items scheduled to be sent including destination or routing information. The customer processor receives carrier rate information for items that may include time sensitive rates that the sender could use in determining when to send items.

### BRIEF DESCRIPTION OF DRAWINGS

FIG. 1A is a block diagram illustrating a mailing information system having a mailing machine used in accordance with an embodiment of the present application.

FIG. 1B is a block diagram illustrating a mailing information system used in accordance with another embodiment of the present application.

FIG. 2A is a flow chart of a method used in accordance with the embodiment described in FIG. 1A.

FIG. 2B is a flow chart of a method used in accordance with the embodiment described in FIG. 1B.

FIG. 3 is a block diagram illustrating a mailing information system used in accordance with another embodiment of the present application utilizing mailing data.

FIGS. 4A and 4B are block diagrams illustrating a data structure for representing mailing data according to the embodiments of the application.

FIG. 5 is a schematic representation of a mailing logistics transportation system used in accordance with another embodiment of the present application.

FIG. 6 is a block diagram illustrating a mailing information system used in accordance with another embodiment of the present application.

FIG. 7A is a flow chart of a method used in accordance with the embodiment described in FIG. 3.

FIG. 7B is a flow chart of a method used in accordance with the embodiment described in FIG. 3.

FIGS. 8A, 8B, and 8C illustrate examples of tabulated data utilized in accordance with the method described in FIG. 10.

FIG. 9 illustrates examples of tabulated data utilized in accordance with an alternative embodiment of the present application.

FIG. 10 illustrates examples of data in chart form utilized in accordance with the method described in FIG. 7B.

### DETAILED DESCRIPTION

The following embodiments are illustrative of certain implementations of the invention of the present application.

Certain markets that operate under the theory of supply and demand may utilize price regulation to drive demand. However, driving demand in the mail delivery service market may advantageously utilize different methods.

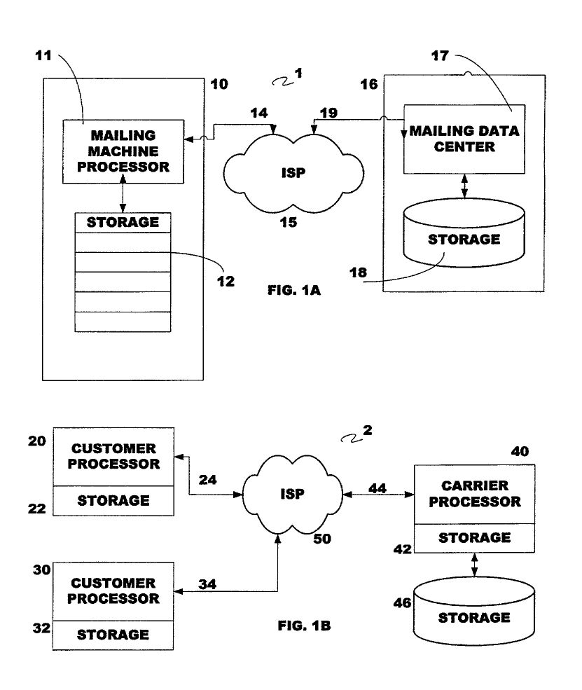

Dynamic Pricing Carrier Rate UpdatesReferring to FIG. 1A, a first embodiment of the present application is described. A mailing information system 1 includes a mailing machine 10 that includes a mailing machine processor 11 and storage 12. The machine processor 11 is an embedded processor, however other processors including a general-purpose processor such as a Windows/Intel platform could be utilized. Storage 12 is non-volatile memory. The mailing machine 10 includes a modem (not shown) for connecting to ISP 15 using a telephone line (POTS) 14. The mailing data center 16 includes a mailing data center processor 17 connected to storage 18. The mailing data center processor is connected to ISP 15 using a telephone line (POTS) 19. The mailing machine processor is a geographically and load balanced application server using systems available from Sun Microsystems and the storage 18 uses multiple location redundant backup systems.

Storage 12 contains at least one memory portion for storing rate and class databases. Additionally, storage 12 includes memory portions for storing usage and customer data. The storage also has memory area for storing program functions for typical mailing machine functions and also has an area for storing program instructions and data relating to rate analysisAs alternatives, other computers and communication channels may be utilized. For example, wireless communications such as a cellular telephone network or satellite system may be used. Additionally, wired networks including LANs, WANs, MANs or the Internet may be utilized. Known security and authentication methods are used to maintain the integrity of the system.

In this embodiment, the mailing machine 10 is configured to store in storage 12 a current default rate and classification database and a dynamic discount rate and classification database. The dynamic discount rate and classification database includes availability and qualification fields such as a beginning time and expiration time field as well as a total discount piece count field for each classification. In this embodiment, both databases are stored in non-volatile memory and interrogated by the mailing machine processor at appropriate times. A particular dynamic discount rate will be used to override the corresponding default rate when it is available and qualified for use. In an alternative, the customer user is offered the choice of whether or not to use an available discount rate.

A reference describing a carrier manager librarian system for utilizing multiple carrier rating systems is shown in U.S. Pat. No. 6,078,889, issued Jun. 20, 2000 to Boucher, et al. ('889 patent), which is incorporated herein by reference.

For example, the postal authority may wish to get an early start to processing Christmas mail and may offer a discount to the non-work-sharing First Class 1 once standard size rate only during the week that is one week before Christmas. The postal authority might decrease the rate from $0.37 to $0.30 for the week before Christmas. Similarly, a postal authority may determine for a particular quarter that the postal authority intake facilities are underutilized on Thursdays and may offer a discount for that day by way of a secondary rate database instead of changing the default rate database to reflect the change.

In an alternative embodiment that may not be available to all postal authorities, the discounts may be offered on an individual or group basis that is not universally available to all users of the system. In that instance, the mailing data center processor 17 maintains discount records for each customer offered them and addresses the secondary rate database to one or a group of particular mailing machine processors 11 by utilizing identification data. Additional embodiments utilizing such non-universal rates are described herein.

In another alternative embodiment, the mailing information system 1 utilizes only one rate and classification database that is dynamically changed when applicable. For example, a discount rate that expires in one day may be downloaded in place of the current default rate and classification database. Thereafter, the default rate and classification database is returned to use in the mailing machine processor at the appropriate time when the discount rate and classification database is no longer being utilized.

As can be appreciated from the description of the various embodiments, the secondary rate and classification database is described in its preferred embodiment as a discount rate database. However, in an alternative to the embodiments, certain rates may be dynamically increased. Such an increase may be used to dissuade customers from unnecessarily using the mailing channel during peak times. For example, the First Class 1 once standard size rate during the Christmas peak season could be increased from $0.37 to $0.40 for the week before Christmas.

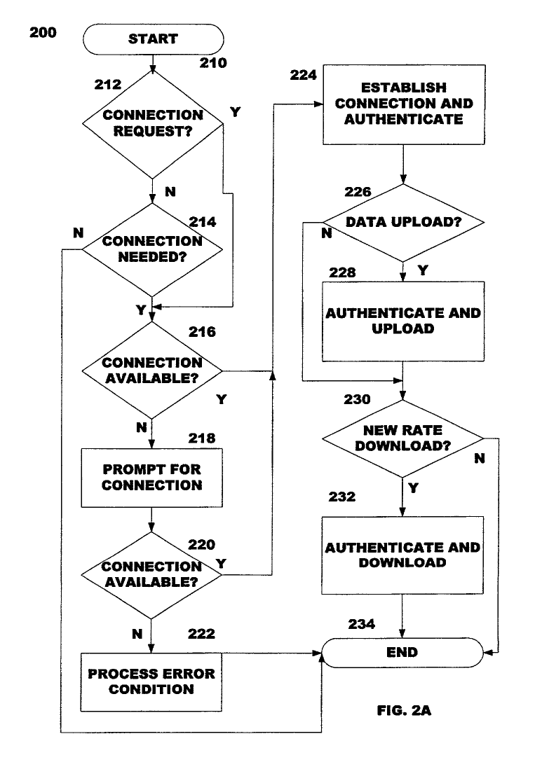

Referring to FIG. 2A, a method for coordinating the download of an appropriate secondary rate and classification database is shown. The update process 200 begins in step 210. In step 212, the mailing machine processor determines whether the operator or a mailing machine setting has requested an immediate link to the mailing data center 17. If so, the process proceeds to step 216. If not, the process proceeds to step 214 to determine if a connection is required. The process utilizes a timeout of one day to ensure that the mailing machine only checks for updates once a day. Alternative time schedules may be used in addition to other criteria such as change in usage patterns. If no update is required, the process ends. If an update is required, the process proceeds to step 216 to query whether a connection is available. In this embodiment, the mailing machine processor 11 utilizes the modem to determine if a connection is possible. If a connection is not possible, the process proceeds to step 218 to prompt the user to enable the modem to connect. The process will then retest in step 220 and process the error and end if not remedied in step 222. If a connection is available, the process proceeds to step 224 and establishes a connection and session utilizing security features such as encryption, authentication and time-outs. In steps 226 and 228 any data upload that is required is processed. In steps 230 and 232, any updates to the secondary rate and classification database are downloaded. The process then terminates in step 234. Mailing data capture and upload includes capturing data regarding mailpieces such as data accumulated into various categories such as those required by certain postal authority regulations including those of the Canadian and Australian postal authorities.

In an alternative also discussed in other embodiments herein, the mailing data center may utilize notification systems to make sure an appropriate user is aware of any secondary rate and classification database. For example, it is possible to obtain and store user contact information having different correspondence addresses for one or more of a variety of communications channels. For example, the mailing data center may maintain contact information for a primary and backup contact utilizing email and facsimile communications. A facsimile server and email server will prepare and send messages including data regarding the temporary rate and classification change. The system may continue contact attempts until acknowledged.

In an alternative method available in any of the embodiments, the mailing data center pushes the discount rate and classification databases to the mailing machines. As can be appreciated, the mailing machines may be connected to the mailing data center using many types of communications channels including an always-available communications channel such as DSL or cable, a scheduled availability channel or an intermittently available communications channel such as a dial up connection via the analog telephone network.

As another alternative, the validity of the default rate and classification database is tested upon connection to the mailing center processor 17 and it is updated if it is expired. As can be appreciated, the mailing data center 16 and associated processor 17 may be provided by a postal authority or by another entity such as a postage meter manufacturer.

As another alternative, the mailing data center 17 arranges for a rate and classification algorithm to be installed for use on mailing machine processor 11 in order to dynamically change rate data depending upon usage of the mailing machine. The algorithm and associated discounts may be provided to the user or they may not be.

As another alternative, the mailing data center 17 collects or is provided other information about one or more of the customers. The additional information may be utilized in determining whether a discount rate is provided. For example, the mailing data center 17 may monitor whether a particular customer utilizes rate shopping features that allow a customer to compare rates of competing carriers for the same or similar service or multi-carrier services. In such a situation the mailing data center may target such customer for a targeted discount because the customer has provided evidence that price is a factor considered in purchasing the service. Additionally, the system may utilize information about special services purchased such as delivery confirmation in an attempt to influence the customer's behavior as a direct marketing tool.

As another alternative, in a system that has class rate breaks at 50 grams and 100 grams, the postal authority may wish to discount items in the lower part of the 51-100 gram range because the cost to deliver is nearly the same as a 50 gram letter.

Dynamic Pricing Carrier Rate Updates in a Manifest SystemReferring to FIG. 1B, a second embodiment of the present application is described. A mailing information system includes a first customer processor 20 having storage 22 and a second customer processor 30 having storage 32. The customer processors 20, 30 are Pentium 4 based computers having disk-based storage 22, 32. However, other processors such as embedded or distributed processors may be utilized. The customer processors utilize communications channels 24, 34 to connect to the Internet 50. The communications channels are always-available DSL connections, however any TCP/IP or other available connection may be utilized. The carrier processor 40 includes local storage 42 and remote storage 46. The carrier processor 40 is connected to the Internet 50 using a communications channel 44 that is an alwaysavailable DSL connection using a firewall. Alternatively, Virtual Private Networks may be established between the processors. The carrier processor 40 is a geographically and load balanced application server using systems available from Sun Microsystems and the storage 46 uses multiple location redundant backup systems.

As alternatives, other computers and communication channels may be utilized. Known security and authentication methods are used to maintain the integrity of the system.

The first and second customer processors 20, 30 are each configured to store in storage 22, 32 a current personalized default rate and classification database and a personalized dynamic discount rate and classification database. Each dynamic discount rate and classification database includes availability and qualification fields such as a beginning time and expiration time field as well as a total discount piece count field for each classification.

Before offering a dynamic rate, the carrier processor 40 confirms that the dynamic rate is better than the particular default rate by checking against a stored user profile. However, as an alternative, the customer processor 20, 30 may make such determination after dynamic rate download, but before use.

In this embodiment, both databases are stored in non-volatile memory and interrogated by the customer processor 20, 30 at appropriate times. A particular dynamic discount rate will be used to override the corresponding default rate when it is available and qualified for use. In an alternative, the customer user is offered the choice of whether or not to use an available discount rate.

The customer using customer processor 20 is a bulk mailer that utilizes controlled acceptance mail (CAM) and a manifest system. The customer processor 20, 30 will be utilized to send data relating to future mailings to the carrier processor 40. The data will include among other things the number of pieces and total weight by class, destination by zone as well as an estimated time of deposit with the carrier and a no-later-than time of deposit with the carrier. In an alternative, each mailpiece can be uniquely identified and be associated with individual origination, destination, size, weight, class, service, and deposit time information fields. In this embodiment, the customer processors 20, 30 are utilized to upload the manifest data to the carrier processor 40. Here, the carrier processor could alert the customer processor of discount rates that were not utilized.

Here, the manifest system is used as a reservation system for discounts. As customer processors 20, 30 upload each manifest, the carrier processor 40 can use that information to apportion available discounts and transmit that information back to customer processors 20, 30 as a dynamic rate and classification database. One customer 20 may reserve all discounts before customer 30 acts.

For example, the postal authority may wish utilize underutilized capacity in a particular intake station. The customer 20, 30 may make a non-binding or binding reservation of capacity as a request into the availability of discounts. The availability of discounts is then transmitted in some form to the customer who can act on the information. The availability of the discounts could be broadcast such as on the Internet or by a contact list procedure as discussed above.

For example, on a particular Thursday at a particular regional CAM mail intake facility, the postal authority has significant over capacity. The machinable First Class 1 once standard size rate could be reduced by 10% for a particular mailer based upon the present manifest request.

In an alternative embodiment that may not be available to all postal authorities, the discounts may be offered on an individual or group basis that is not universally available to all users of the system.

Referring to FIG. 2B, a method for coordinating the download of an appropriate secondary rate and classification database is shown. The update process 250 begins in step 251. In step 252, the customer processor 20 determines whether the operator or a parameter setting has requested an immediate link to the carrier processor 40. If so, the process proceeds to step 256. If not, the process proceeds to step 254 to determine if a connection is required. The process utilizes a timeout of one day to ensure that the customer processor 20 checks for updates at least once a day. Alternative time schedules may be used in addition to other criteria such as change in usage patterns. If no update is required, the process ends. If an update is required, the process proceeds to step 256 to upload a reservation manifest and a time required for reply. The customer processor then polls for a reply in step 258 and if available in step 260, a dynamic rate and classification database is downloaded. In step 262, an acknowledgement is sent and then the process ends. The acknowledgement may be sent via the network or by facsimile, email or other communication methods.

In an alternative, the carrier processor center 40 may utilize notification systems to make sure an appropriate user is aware of any secondary rate and classification database. For example, it is possible to store user contact information having different correspondence addresses for one or more of a variety of communications channels. For example, the mailing data center may maintain contact information for a primary and backup contact utilizing email and facsimile communications. A facsimile server and email server will prepare and send messages including data regarding the temporary rate and classification change. The system may continue contact attempts until acknowledged.

In an alternative method available in any of the embodiments, the carrier data center 40 pushes the discount rate and classification databases to the customer processors based upon historical manifests. Systems utilizing historical data to target discounts in order to influence customer system usage to better utilize capacity are discussed herein.

As another alternative, the function of the carrier processor may be performed by a mailing data center operated by a third party.

Incentive Determination Carrier system managers must consider transportation and distribution network costs in terms of capital costs and operating costs and yet provide the desired service level and consistency of service. Certain carrier system managers may be able to schedule capacity well in advance. For example, a truck owner/operator may make advance reservations for his services. Other carrier systems such as a postal system may not know in advance what items are to be shipped. A postal service may utilize historical processing data to forecast future mail volume, but such forecasting may be inaccurate.

The USPS typically sets postal rates for various classes of mail that vary depending upon mailpiece characteristics such as weight and sizes and vary depending upon service characteristics such as the time allowed for delivery. Additionally work-sharing related discounts are also considered.

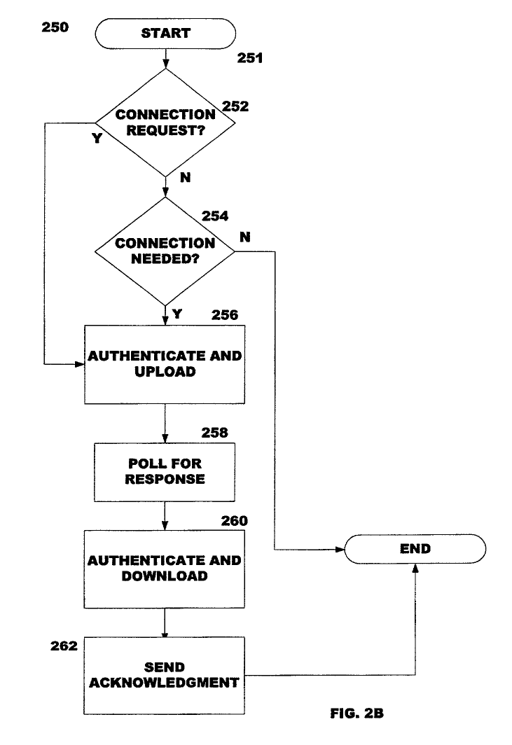

Referring to FIG. 3 a mailing information system 3 used for among other things capturing and reporting data related to mailing data is shown.

A reference describing a postage metering system is U.S. Pat. No. 6,081,795 issued to Ryan on Jun. 27, 2000, and incorporated herein by reference. Additionally, a reference describing a method and system for franking, accounting and billing mail services is U.S. Pat. No. 5,717,596 issued to Bernard, et al. on Feb. 10, 1998 and incorporated herein by reference.

Mailing information system 3 is an illustrative example of a mailing information system according to the present application. As with the all the illustrative embodiments and examples herein, it is contemplated that additional customer processors could be connected to the system as well as additional data center processors.

Each of four customers: A, B, C, and D utilize a mailing machine such as those available from Pitney Bowes Inc. The mailing machines, 310, 320, 330 and 340 are connected to a communication channel 350 using communication channels 312, 322, 332, and 342 respectively. Communications channel 350 is the Internet in this illustrative embodiment. The communications channels are preferably secured using known methods. A firewall 352 regulates traffic between the communications channel 350 and meter services data center 360 along communications channel 362. Meter services data center 360 is connected to postal authority data center 370 using a secure communications channel such as a dedicated leased line. Alternatively, a VPN may be utilized over the Internet. Postal authority storage 382 is connected to postal authority processor 370 using communications channel 382.

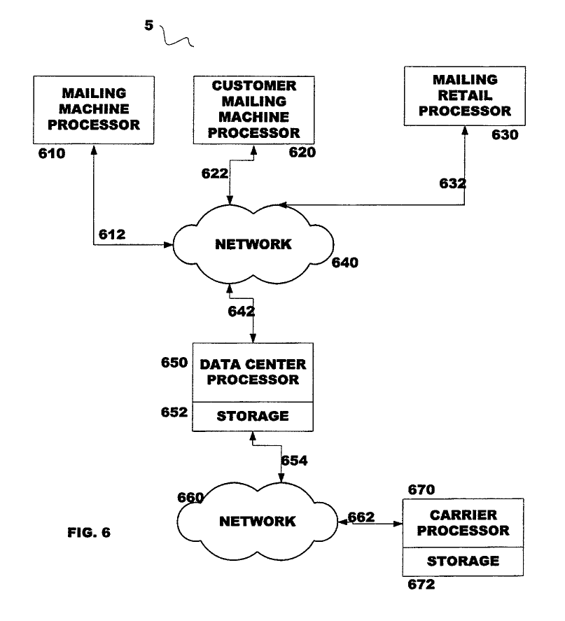

Referring to FIG. 7A, a closed loop, iterative service-pricing incentive determining algorithm 700 is described. In step 710, usage and customer data is sent to the post. Postal usage data and customer data may be collected by several methods including customer profiles that include among other things location and quantity of meters. Historical volume may be saved. Cookie data may be obtained such as utilization of features, use of special services, and use of rate shopping. Postal usage data systems are described herein.

In step 712, the postal authority data center 370 determines whether a discount is applicable for such data. For example, a customer located in a particular location may qualify for one discount. Several discounts may be applicable and may be reconciled into a compatible discount bundle. In step 714, the process determines if the customer is eligible for a discount. If the customer is not eligible, the process loops to step 710. If the customer is eligible, the post offers the discount in step 716 by sending a message to the meter. Alternatively, the process could utilize facsimile, email or telephone communications among other methods to notify of the discount. Similarly, the discounts could be publicly or privately posted on the Internet.

In step 718, the customer decided whether to utilize the discount. If the customer does not utilize the discount, the process returns to step 710. If the customer utilizes the discount, the process proceeds to step 720 wherein the new rate and data capture rules are downloaded to the mailing machines and used by the customer while the rates are effective. The process then proceeds to step 722 where usage and customer data is sent to the post and the process then analyses the data on usage and other effectivity criteria to determine if algorithm changes are needed and then the process loops in a closed loop back to step 712.

In step 724, if the postal authority is attempting to manage capacity of part of its logistics chain, the post may know that it was 80% effective in getting the mail volume adjusted in that segment, the next iteration can target 125% of the previous customer population in order to try and get effectivity levels of 100% calculated as the product (0.8)(1.25).

In step 710, the postal authority determines a schedule for data uploads based upon a periodic upload schedule that may be changed, as data needs change. The schedule may be altered when a discount is in use to provide additional data used in determining when the discount was being effective or needed to be changed. For example, a daily upload could be modified to run every five minutes during a discount period.

Each customer may utilize differing data upload schedules and off schedule uploads may be utilized when needed. As an alternative, the data transfers could be accomplished whenever a meter connects to the network.

Appropriate standard handshaking and security measures are put into place. The communication schedule can vary to take into account communication channels that are not always available and to balance communication levels.

In step 714, an example of an algorithm used to determine customer eligibility is to utilize historical data as to customer usage. Customer eligibility may be determined based upon historical usage and conditional probabilities of mail volume. For example, mailer A typically runs 30,000+/−5000 mailpieces, while customer B runs 15000+/−10000 a week, both with 95% confidence. Based upon this profile, customer A may be target for an incentive (or targeted for a disincentive) in order to affect the behavior of customer A to achieve a desired volume. As can be appreciated, customer B may have too much volume variation to be an effective target of the incentive. However, there may be other incentives that are more likely to affect the behavior of customer B in a desired manner.

In an alternative, the algorithm processing could be performed at the meter services data center 360 and audited by the postal authority and could also be processed directly in the meters 310, 320, 330, 340. A combination of processing locations may also be utilized so that multiple algorithms for determining discounts may be running and then the results reconciled.

In an alternative using more than one data center, a routing processor or distributor is placed between the customer processors and the data center processors in order to route the customer to the appropriate data center that may be organized on a country-by-country basis.

The meter services data center 360 is connected to the postal authority data center 370 and storage 380. Communications channel 385 is used to contact the customer contact information listed for a particular customer including email, facsimile, and computer synthesized voice interaction.

Meter services data center 360 maintains a database of customer contacts and contact method preferences in order to communicate with customer contact 390. The meter services data center 360 may also communicate with customers through the meters 310, 320, 330, and 340. For example, the meter services data center may notify customer contact 390 of a discount rate via facsimile using a facsimile server and communications channel 385. Alternatively, email or voice communications may be utilized. In an alternative, the postal authority data center 370 may communicate with customer contact 390 using similar communications channels.

In an alternative, postal authority data center 370 receives information from additional meter services data centers that are operated by different meter manufacturers and having different data center networks. Additionally, bulk mailers and similar mail users that use manifest systems are integrated into the system through the meter services data center. Additionally, other postal system customers such as retail customers may be integrated into the system by way of a kiosk or retail counter processor.

In another alternative, storage 380 includes customer data other than data relating to the number of mailpieces sent. For example, the postal authority data center 370 may target customers for discounts based upon other criteria. A mail data center may capture information regarding which customers utilize rate-shopping features when purchasing shipping services. In such instances, that customer may be provided a targeted discount, as such a customer may be more likely to respond to or notice a price difference among competitors for a service. Alternatively, the customer data could be retrieved and stored at the meter services data center 360. In another alternative, the customer processors use a cookie system to capture customer data.

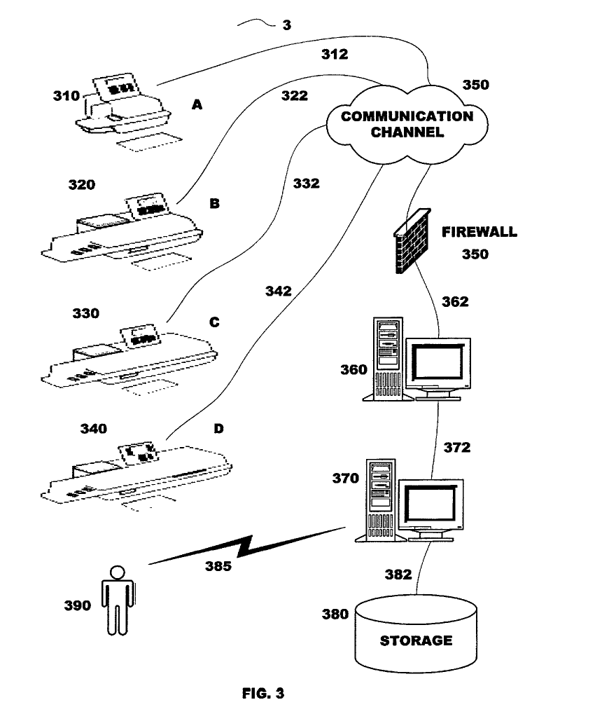

Usage DataReferring to FIG. 4A and FIG. 4B a data structure used in a mailing information system for capturing and reporting data related to mailing data is shown. A mailing machine typically includes a postage meter that for a closed system postage meter includes or has access for one or more postal value accounting devices. A mailing machine may also be used to capture data regarding the mailings processed.

Referring to FIG. 4A, a mailing machine M1 400 includes data records that are stored in non-volatile memory. In this implementation, the data is stored in a daily data record 405 and the data is captured by class of service and accumulated on an hourly basis into data accumulation buckets that maintain running totals of usage during the sample period of one hour.

Here, the first class of service A is defined as an Express Class of Service and the data includes a data bucket A1 410 to store the accumulation totals for the first hour of a day. As can be appreciated, hourly buckets 410, 412 through A24 418 are utilized. Similarly a second class of service B is defined as First Class service and includes buckets B1 though B24, 420, 422, and 428.

Additional classes of service are define through Z which is a standard service level and includes buckets Z1 though Z24, 430, 432, and 438. As can be appreciated, each class of service could be divided into automation and work-sharing sub classes.

In this example, a separate daily record 405 is maintained for each day.

Referring to FIG. 4B, an individual bucket is shown. The bucket A1 410 includes records related to mailpiece data including a running total of weight that is known electronically by the mailing machine including a scale 451, weight determined by dimensional estimation techniques 452, weight values input by an operator 453 or a weight determined by the class utilized 454. Bucket A1 410 also includes a running total of the number of pieces 355 and a running total of the postage value applied 356. Additionally, information relating to special services is captured including the total value of special services 357.

As can be appreciated, for window or mail receptacle customers, data can be captured on a single or small batch basis. For controlled acceptance mail customers, preliminary data in the nature of a capacity request or reservation can be utilized, or processed data can be captured such as the information available on a manifest.

In an alternative, each bucket is maintained in a least common denominator group size such as a time based sample size of 5 minutes. Thereafter, the data can be aggregated if requested on an hourly basis. As can be appreciated, the same data structure using a least common denominator method could be utilized to satisfy requests for information sampled or organized in multiple configurations.

In an alternative, each mailpiece can be uniquely identified and be associated with individual origination, destination, size, weight, class, service, and deposit time information fields.

Load BalancingA carrier system manager may wish to optimize the carrier transportation and distribution networks to create a flexible logistics network. Such a network may advantageously utilize customer information as well as carrier network information including historical data and real-time feedback of information relating to the current state of the transportation and distribution network capacity.

A carrier may utilize historical performance and capacity/utilization data to reconfigure or optimize the network.

Additionally, as described herein, the carrier may advantageously utilize real-time capacity information relating to the network in order to use dynamic pricing discounts to effect customer behavior in order to utilize current unused capacity in the network. As described below, historical customer data may be used to target the recipients of the targeted dynamic discount, or actual customer queue information may be utilized. The customer processors may be resident in mailing machines, manifest processing systems or a combination of the two. In certain embodiments, individual retail customers may participate. For example, if the New York City to Boston mail stream supports one truck, but the return truck is only half full, the postal authority may target Boston retail customers by offering a discount for mailings from Boston to New York City.

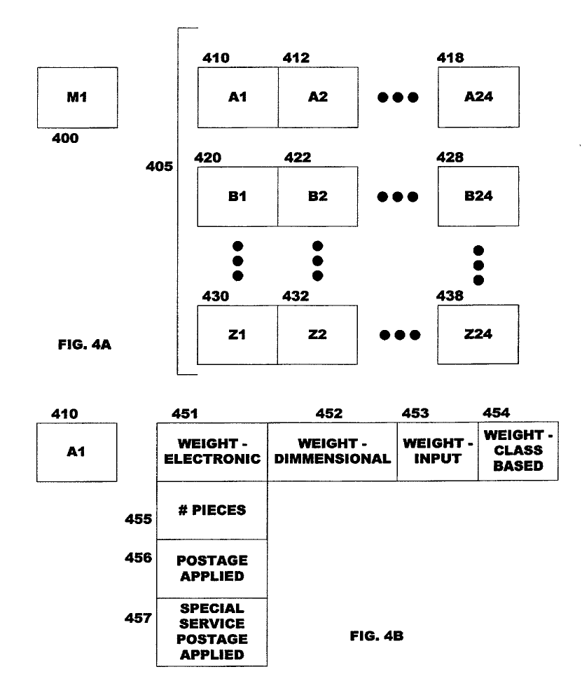

Referring to FIG. 5 another embodiment of the present application is described with reference to a block diagram of a mailing system 4 and is used to describe a system for efficiently utilizing carrier capacity by using dynamic pricing. An illustrative postal authority logistics structure is shown. The postal authority utilizes three regional processing plants 530, 540 and 550. The regional plants are interconnected utilizing truck routes 560, 570, 580, train routes 562, 572, 582, and air routes 564, 574, 584. A customer A has a mail creation facility 510 and delivery fleet 512 that delivers finished mailpieces into the mail stream at one of two local post offices 520, 524. The local post offices are connected to regional processing plant 530 using truck routes 522, 526, respectively.

In an illustrative example, the postal authority utilizes a logistics system that informs it that the region 550 is underutilized for the next day or two. The postal authority or mail data center processor then uses historical customer data to target a discount to customer A for mailpieces with a destination in region 550. In another example, truck route 560 is underutilized for the next day or two. The postal authority or mail data center processor then uses historical customer data to target a discount to customer A for a slow class of mail that can utilize route 560. In another example, the system may have data to indicate that customer A utilizes post office 520. However, post office 524 is underutilized and the postal authority can offer customer A a targeted discount that is only available if customer A utilizes post office 524 for delivery into the mail stream.

In another example, the collection activity of the postal service may be the basis for dynamic pricing. For example, a customer may be offered a dynamic price incentive that is effective for only a certain period of time in order to utilize a period of collection activity capacity that is underutilized. In such a system the postage payment evidencing may include a good until date and time stamp for qualification for a certain discount. In such a system, items delivered outside the designated time period might be returned or processed. If processed, the customer could later be billed for a class step-up fee or fined for non-compliance.

In another example, a postal service may wish to charge for postage based upon among other criteria the distance that the mailpiece is to travel. Such a system may be based upon zones. Additionally, a pricing system may forecast a delivery route such that a pricing scheme may be utilized that more closely approximates actual delivery cost. In such a system, dynamic pricing may be utilized to discount a particular portion of a route that is currently subject to under-utilization such as truck route 560. Accordingly, a system could calculate what source locations and classes of mail could be routed through the underutilized route and offer targeted discounts accordingly.

As another alternative, the post may search for peak mailers. In this example, mailer A has a recent history of placing 100,000 pieces of $0.27 mail in a small postal facility that has difficulty accommodating the influx. As described above, a delivery location based discount may be offered. However, another approach may be used. The mailer A may be offered a $0.26 rate for up to 20,000 pieces of mail per day in an attempt to influence behavior to spread out the burden on the intake facility. The postal authority could then monitor whether the desired behavior was induced and if not, the post could then decide to offer an even greater discount in an iterative process until a preset maximum discount is reached. If the discount is not effective, it could be removed.

As can be appreciated, other utilization based targeted discounts are possible. Additionally, the targeted discounts can be offered to a greater number of customers than required in a system similar to airline reservations in that there is a chance that the discount be oversubscribed. In such a situation, the discount may be honored for all or distributed by a system such as first-come, first-served.

As can be appreciated, a particular mailer may desire one particular discount and not desire a similar discount. For at least one type of delivery item, certain items may be delivered via fundamentally different channels in fundamentally different form. For example, an advertisement might be sent by mail or via facsimile. Each distribution channel may have its own cost benefit analysis such that the mailing might be deemed less effective at a first higher rate, but more effective at a second lower rate. Accordingly, a dynamic discount might encourage new volume at precisely the time transportation and delivery capacity are underutilized.

Customer A 510 may employ a cost-benefit processor to determine when to accept a dynamic discount. For example, certain geographic locations may be known to include households that better respond to mailed advertisements. Accordingly, an advertiser may weight the cost benefit ratio such that a lesser discount may make a mailing to such geographic location advantageous.

As yet another example, certain geographic locations may be known to include more affluent households that purchase more items. Accordingly, an advertiser may apply a cost/benefit analysis that varies across certain demographics.

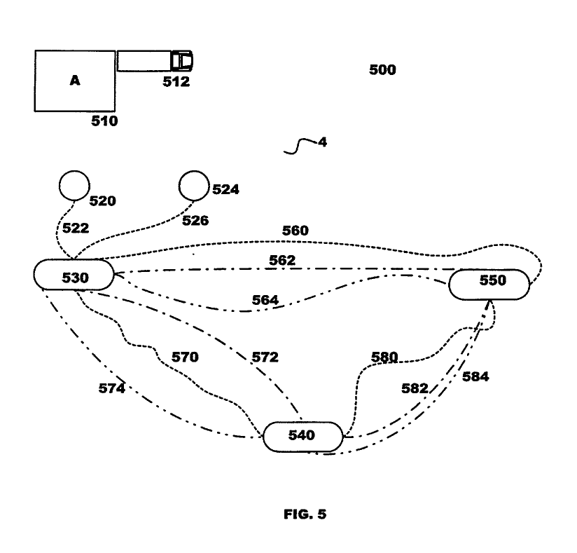

Referring to FIG. 6 another embodiment of the present application is described with reference to a block diagram of a mailing information system 5 and is used to describe a system for uniformly offering targeted discounts to various types of customers.

An illustrative system is shown having the representative processors. The first processor is a representative mailing machine processor 610 such as that used in a system having a closed postage meter. The second processor is a customer mailing machine processor 620 such as that utilized by large mailers that use CAM mailings and manifest systems. The third processor is a retail processor 630 such as the processor at a post office window or kiosk. The processors are connected to network 640 using typical communication channels 612, 622 and 632 respectively.

Data center processor 650 and storage 653 are connected to the customers by network connection 642. The data center processor 650 is connected to the carrier processor 670 using network connections 654 and 662 and network 660. Carrier processor 670 is connected to storage 670.

Accordingly, retail mail users could enjoy the same discount through a system of broadcast discount notices and access to alternative temporary rate discounts at retail locations.

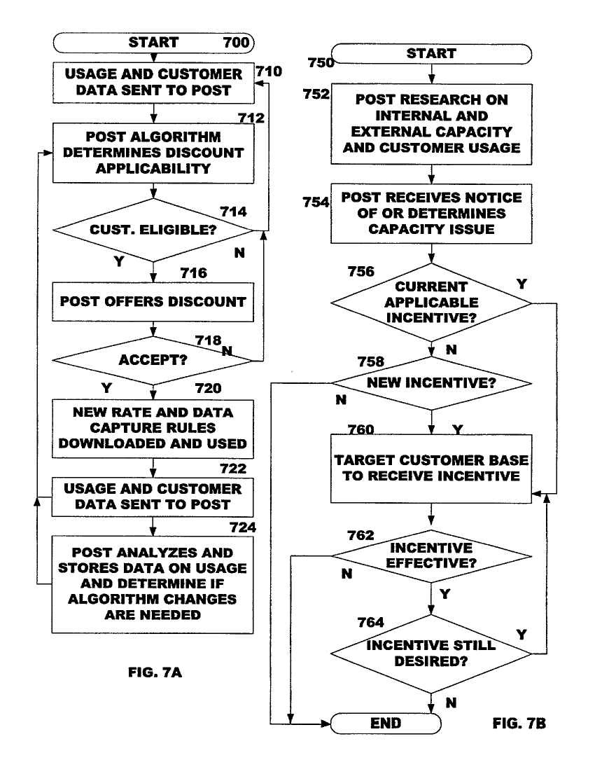

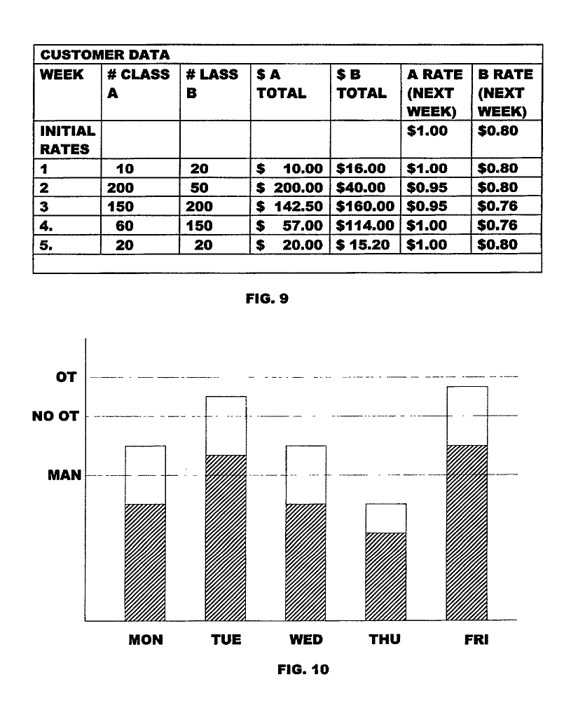

Capacity OptimizationReferring to FIG. 7B and also referring to FIGS. 8A, 8B, 8C and 10, a system for optimizing capacity utilization is described. Referring to FIG. 3, a mailing information system that may be utilized in this embodiment is described. Referring to FIG. 5, a mailing system logistics infrastructure that may be utilized in this embodiment is described.

In step 750, the process starts. In step 752 the post builds a data warehouse on capacity and customer usage. The data warehouse includes logistical information for internal and external logistical sources. The post may utilize third party external services such as truck transport. Capacity planning information is integrated in this step. The post may also consider variable cost factors such as overtime costs.

Elements of the data warehouse include historical usage information such as that shown in FIGS. 8A-8C. For example, FIG. 8A describes the average weekly mail usage for four customers based upon the percentage usage for each of a group of classes. The database could also factor in confidence levels or maintain seasonal averages. In FIG. 8B, the average weekly volume of mailpieces by class is maintained for each customer. In FIG. 8C, a postal authority mail classification service level table is shown. In this example, the postal authority targets or guarantees certain delivery performance criteria based upon the class level. As shown, slow mail can be delayed for up to four days, D1-D4, but becomes mandatory on day 5. Accordingly, on Day 5, an unprocessed slow mailpiece would be processed in the same manner as an express mailpiece. Accordingly, the original priority of the slow mailpiece is converted into a modified priority.

Referring to FIG. 10, a chart showing postal logistical capacity by modified priority for mailpieces against the capacity of the post for no overtime (NO OT) and overtime (OT) situations with a mandatory capacity level (MAN). This data can be built from historical usage data and can be generated based upon real time data input from customers including a real time link to postage meters of a customer.

In step 754, the post receives notice of or determines the existence of a capacity issue such as a capacity anomaly. For example, there may be a short term issue identified such as low daily mailpiece volume such as shown on FIG. 10 for Thursday assuming that FIG. 10 represents real time data for all or part of Thursday.

Additionally, a long-term issue may be identified such as insufficient use of a highly profitable mail class that is determined by mining the data warehouse used in step 752. Furthermore, a seasonal impact such as high volume of the Christmas mail rush may be identified as a target opportunity for incentives.

Additionally, a post could be notified of a logistics anomaly on a micro or macro level such as weather conditions that impact routes shown in FIG. 5, or the case of excess capacity on a return route.

As an example, in step 754 we may determine a chart such as FIG. 10 having real time data to show a projected short fall in volume on Thursday and have historical data for Friday showing excess mandatory volume that would require costly overtime and reduce profitability. Accordingly, the process proceeds to step 756 to determine if an applicable incentive exists. Assuming that one does not, the process proceeds to step 758 and determines whether a new incentive could be created. Here for example, the algorithm would determine that a price discount for express mail to push Friday express mail to Thursday would be a best-fit solution for an incentive top produce the desired result. A set of rules and weightings could be utilized as an expert system to identify, define and target discounts. It may be based upon rules input to the system or those rules and patterns learned by the system. Such rules might involve mining data periodically or when needed.

Accordingly, in Step 760, the process searches for the appropriate customer or customers to target. Here, for example, customer D uses a large volume of express mail. We could query how much he has sent so far in the week and determine to offer an incentive to customer D that is available only the current Thursday. For example, customer C would not be an appropriate choice for the incentive because they do not typically use express mail and have a low volume of standard mail that may become mandatory when it is not processed early.

In step 762, the process determines if the incentive was effective and can adjust accordingly. In step 764, the process decides if the incentive is still desired.

As can be appreciated, an incentive may be open ended subject to revocation in step 764.

Additionally, a least-common-denominator data structure or sampling may be utilized so that the database can be normalized to different sample periods or other query parameters.

As can be appreciated, the ability to utilize real time partial period data is advantageous to the embodiment. For example, a post may have a period deadline such as a plane departure. The post could use partial period forecasts during the day to determine whether to offer an end of the day discount.

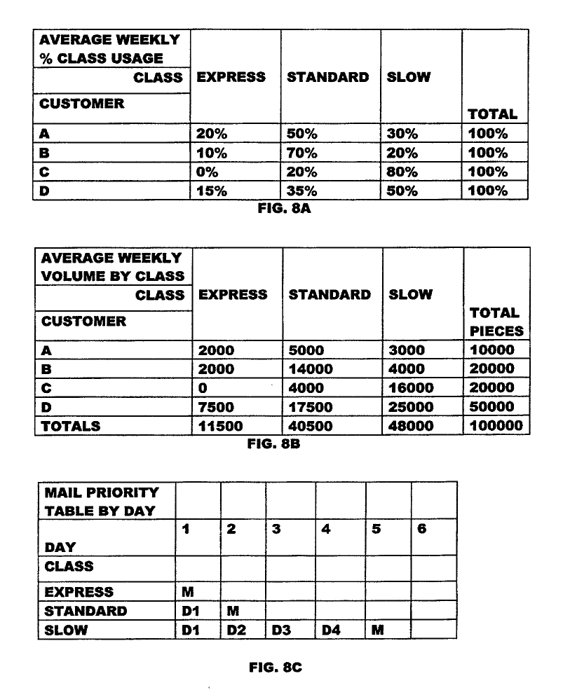

Customer Specific IncentivesReferring to FIG. 9, one alternative of an embodiment of the present application describes a system in which the ability is provided to generate and supply custom postal discounts via customer specific postal rates based on each specific customer in real time or in fixed-increment periods. Referring to FIGS. 1A, 1B, 3 and 6, mailing information systems are shown that could also be utilized for this alternative embodiment. The system described creates a new method for a postal authority to provide incentives to the customer population to try to maximize postal system profitability and influence their customers to use the most cost effective and efficient rate classes on an individual basis.

The usage data from the postage meter can be analyzed over an internet infrastructure to determine if it meets a postal criteria for achieving a discount level for postage rates or a customer specific postal rate structure by analyzing the data using an algorithm approved by the postal authority. The results of the analysis algorithm can be immediately downloaded into the mailing machine providing a real time customization and/or optimization of the postal rate structure within a mailing machine.

One alternative of this embodiment describes the creation of customer specific postal discounts through the modification of their rate structure on a real time basis. As data capture information record is recorded and analyzed over a period of time. An algorithm or set of rules is used to determine if a customer is eligible for discounts in their postal rates. The discounts may be implemented in a number of ways, not limited to a flat percentage discount across all rate classes, a discount in one or more specific rate classes (incentives to utilize classes of mail more often), time sensitive discounts for rates (ability to run the same rate class of mail at a discounted rate before 12:00 p.m.), or completely customer specific postal rates intended to optimize postal revenue. The algorithm can be changed over time, as the postal authority needs change. The discounts can be analyzed at any interval (either real time or with a specific periodicity) specified by the post and modified (increased or decreased per the rules of the algorithm). Feedback is provided to inform both the customer and the post of the changes to their rate structure.

Feedback in the form of data relating to the utilization of the discounts/rate modifications is also provided to the postal authority. The postal authority can develop metrics relating to effectiveness for specific marketing campaigns, load balancing programs and work-sharing efforts. The postal authority may also determine sensitivities for changes to the rate structure using pricing algorithms. Several pricing algorithms are available. An example of a reference describing point of sale goods marketing in response to a customer shopping history is shown in U.S. Pat. No. 6,334,108 to Deaton, et al., and incorporated herein by reference.

The following example is used for illustrative purposes. A customer has a networked postage meter with a default postage rate set. The Customer uses the postage meter to produce indicia on the mailpieces that evidence the payment of postage. The postage meter accounts for the used postage. The postage meter also captures required usage data in a storage area. At a defined periodicity having a default set at one day (could also be real time or at some fixed-increment based on time, meter usage, or some other metric), the meter connects to Internet infrastructure to upload data and so that the data may be analyzed. The postal authority algorithm is executed at the mailing data center. The output of the algorithm determines if that customer requires a change to their rate structure. The change to the postal rate structure can be the granting of one or more discounts, the removal of one or more discounts, a penalty, or a combination thereof. The algorithm could also output an entirely custom set of rates for that customer. Confirmation of the changes to the rate structure are sent both to the customer and to the postal authority informing them of the changes made to the rate structure.

In another alternative, the postage meter stores the post-supplied algorithm to calculate discounts as mail is processed. Once a threshold value is exceeded, the meter is locked out from further use until a connection is established with the infrastructure to communicate this threshold value and download new postal rates.

Referring to FIG. 9, an example of this alternative embodiment is described. In an illustrative simple rate structure, two rate classes exist. Class A service costs $1.00 each mailpiece and Class B service costs $0.80 for each mailpiece. The Postal Authority Supplied Algorithm has the following rules. 1) If more than $100 of a class of mail is produced during one week (ending each Sunday at midnight), the next week a customer will get a 5% discount for all mail pieces produced in that class; 2) A customer shall lose the discount if $75 of mail in a discounted class was not used in the subsequent week; and 3) A meter must connect for an inspection after each Sunday at midnight before new mail can be created.

As can be appreciated, a comprehensive rating algorithm could be approved once in a rating litigation and then utilized. Such a system has significant advantages over litigating every single discount desired.

Based on the customer's usage patterns, the new rate structure would have been downloaded after each inspection if there was a change based on the output of the algorithm. There would have been customized rates downloads occurring after weeks 2, 3, 4 and 5.

Here, the mailing machine includes a processor with a first memory for storing a primary rate database, a second memory for storing temporary rate data, a third memory for storing rating instruction data and a fourth memory for storing usage data. The processor determines a rate determination such as a discount or penalty using the rating instruction data and usage data. It may also determine a rate applicability determination using the rate determination and the primary rate database such that for example, a discount that is not a discount from the primary rate is not used. The temporary rate data may have an expiration date or may be periodically cleared. As discussed above, the rating determinations may be made using a combination of processors such as the mail data center and the mailing machine processor.

The embodiments described above may be modified such that they utilize a discount notification system whereby the delivery service provider notifies a particular customer of a time-sensitive discount by providing the notice to one or more notification locations using communication channels as specified in a customer profile. A particular customer may indicate that any one or all of facsimile, e-mail, express mail or other communications channel should be utilized to provide the discount notifications. For example, a computer synthesized voice system may be utilized to automatically generate and send voice messages to a telephone number that may be answered by a person or an answering device that would record the message.

The present application describes illustrative embodiments of a system and method for optimizing postal rates and discounts. The embodiments are illustrative and not intended to present an exhaustive list of possible configurations. Where alternative elements are described, they are understood to fully describe alternative embodiments without repeating common elements whether or not expressly stated to so relate. Similarly, alternatives described for elements used in more than one embodiment are understood to describe alternative embodiments for each of the described embodiments having that element. The illustrative embodiments discussed herein describe postal rating systems but the invention of the application may be advantageously applied to other systems.

The described embodiments are illustrative and the above description may indicate to those skilled in the art additional ways in which the principles of this invention may be used without departing from the spirit of the invention. Accordingly the scope of the claims should not be limited by the particular embodiments described.

1. A mailing machine comprising:
a processor;
a first memory portion operatively connected to the processor for storing a primary rate database;
a second memory portion operatively connected to the processor for storing temporary rate data;
a third memory portion operatively connected to the processor for storing rating instruction data; and
wherein the processor determines a rate applicability determination using the rating instruction data, the primary rate database and the temporary rate data.

2. The mailing machine of claim 1 further comprising:
a fourth memory portion operatively connected to the processor for storing usage data; and
wherein the processor determines a rate determination using the rating instruction data and usage data and determines a rate applicability determination using the rate determination and the primary rate database.

3. The mailing machine of claim 2 wherein:
the temporary rate data comprises a temporary rate database having expiration data; and
wherein the processor determines a rate applicability determination further using the temporary rate database.

4. The mailing machine of claim 3 wherein,
a portion of the rate determination is received from an external processor and stored in the temporary rate database.

5. The mailing machine of claim 2 further comprising:
a fifth memory portion operatively connected to the processor for storing customer data.

6. The mailing machine of claim 5 wherein:
at least a portion of the customer data is obtained utilizing a cookie.

7. The mailing machine of claim 4 wherein:
at least a portion of the customer data is obtained utilizing a cookie; and
at least a portion of the rate determination is received from an external processor that received the cookie.

8. The mailing machine of claim 2 wherein:
the temporary rate data is cleared periodically.

9. The mailing machine of claim 8 wherein:
the period for clearing the temporary rate data is every 24 hours.

10. A mailing machine comprising:
means for processing instructions and data;
a first memory means for storing a primary rate database for access by the processing means;
a second memory means for storing temporary rate data for access by the processing means;
a third memory means for storing rating instruction data for access by the processing means; and
wherein the processing means includes means for determining a rate applicability determination using the rating instruction data, the primary rate database and the temporary rate data.

11. The mailing machine of claim 10 further comprising:
a fourth memory means for storing usage data for access by the processing means; and
wherein the processing means includes means for determining a rate determination using the rating instruction data and usage data and for determining a rate applicability determination using the rate determination and the primary rate database.

12. A method for dynamically changing rating information for at least one customer comprising:
receiving customer usage data for a plurality of customers;
receiving customer data for a plurality of customers;
obtaining logistics data for a mailing logistics system;
determining desired volume changes by class;
targeting at least one customer having a mailing machine for a discount in the class;
creating a temporary rate database; and
sending the temporary rate database to the mailing machine.

13. The method of claim 12 further comprising:
receiving data relating to customer usage of the discount; and
determining whether to adjust the discount.

14. A method for determining temporary rate data using a mailing machine comprising:
obtaining rating instruction data;
obtaining usage data; and
processing the rating instruction data and usage data to determine a rate determination.

15. The method of claim 14 further comprising:
obtaining primary rate data; and
processing the primary rate data to determine a rate applicability determination.

16. A method for determining targeted incentives using a carrier information system having feedback comprising:
obtaining customer usage and customer data;
determining whether an incentive is desired;
determining whether a customer is eligible for an incentive;
offering the customer an incentive;
obtaining incentive related usage data; and
analyzing the incentive related usage data to determine effectivity, determining whether to modify the incentive.

17. The method of claim 16 wherein:
the customer usage data is obtained from a mailing machine.

18. The method of claim 16 wherein:
the incentive is a time based discount for at least one particular class of mail.

19. The method of claim 16 wherein:
the incentive is a penalty.

20. The method of claim 16 wherein:
determining whether an incentive is desired includes, analyzing historical usage data, analyzing partial period usage data, forecasting capacity demands and targeting at least one customer likely to require the applicable mailing services to be discounted.
